(19) United States
(12) Patent Application Publication
(10) Pub. No.: US 2007/0268247 A1
(43) Pub. Date: Nov. 22, 2007

(54) MOBILE TABLET COMPUTER

(76) Inventor: Cary Quatro, Byron Center, MI (US)

Correspondence Address: ROBERT J. SAYFIE, P.C., 161 OTTAWA AVENUE NW, SUITE 407, GRAND RAPIDS, MI, 49503, US

(21) Appl. No.: 11/419,514

(22) Filed: May 22, 2006

(51) Int. Cl. G09G 5/00

(52) U.S. Cl. 345/156

(57) ABSTRACT

Disclosed is a mobile tablet computer comprising: a central body housing a processing unit, at least one handle coupled to the central body, and a plurality of ergonomic user interface features disposed on the handle. The central body has a display screen. The handle serves as a handgrip for holding the mobile tablet computer. The ergonomic user interface features comprise a plurality of control buttons for inputting data to the mobile tablet computer, and a scroll wheel for positioning data displayed on the display screen.

### FIELD OF THE INVENTION

The present invention relates generally to portable computing devices, and more particularly, to mobile tablet computers for use in rugged environments.

### BACKGROUND OF THE INVENTION

During the past few years, the popularity of portable computing devices has grown significantly. The portable computing devices range from straight forward devices used to look up appointments and phone numbers to more sophisticated units that may be used to play music and videos or connect to the Web. The most significant trend is the use of portable computing devices, for example, tablet computers, for communication via wired or wireless networks.

The introduction of tablet computers with pen-based input and handwritten recognition features has changed the way people interact with computing devices. Tablet computers offer many potential benefits and advantages, and are being widely used for personal computing purposes, business applications, and emergency purposes. Such tablet computers offer the portability of a laptop or notebook computer, and also the increased screen size, power and performance of a desktop computer. The portability in the tablet computers is achieved with incorporation of user interface features that replace bulky keyboards and mouse. For example, the tablet computers may have a touch screen functionality that allows a user to operate the computer with a stylus or digital pen instead of a keyboard or mouse.

However, the user interface features may be disposed on the tablet computer in such a way that the user may find it uncomfortable to operate the user interface features, thereby making the operation of the tablet computer ergonomically inefficient. Further, firefighters wearing bulky gloves and other personnel working in rugged environments may find it uncomfortable to operate the mobile tablet computer due to the ergonomic inefficiency in the disposal of the user interface features on the tablet computers. Also, in rugged environments, the usage of the tablet computers may result in subjecting the tablet computers to unsuitable conditions that may damage the tablet computers, more specifically, damaging the delicate user interface features like slot covers, wheels, and pens that can be broken or lost during rough usage. Such tablet computers may be easily prone to wear and tear. Water and dust contamination may also contribute to the damage of the tablet computers.

Accordingly, there exists a need for a tablet computer that can be used in rugged environments without getting damaged, and also providing features for improved ergonomic operation of the tablet computer.

### SUMMARY OF THE INVENTION

In view of the foregoing disadvantages inherent in the prior art, the general purpose of the present invention is to provide a mobile tablet computer, to include all the advantages of the prior art, and to overcome the drawbacks inherent therein.

In one aspect, the present invention provides a mobile tablet computer. The mobile tablet computer comprises: a central body housing a processing unit, the central body having a display screen; at least one handle coupled to the central body, the handle serving as a handgrip for holding the mobile tablet computer; and a plurality of ergonomic user interface features disposed on the handle. The ergonomic user interface features comprise a plurality of control buttons for inputting data to the mobile tablet computer, and a scroll wheel for positioning data displayed on the display screen.

In another aspect, the present invention provides a mobile tablet computer. The mobile tablet computer comprises: a central body housing a processing unit, the central body having a front surface with a display screen; at least one handle coupled to the central body, the handle serving as a handgrip for holding the mobile tablet computer; and a plurality of ergonomic user interface features disposed on the handle. The ergonomic user interface features comprise: a plurality of control buttons for inputting data to the mobile tablet computer; a scroll wheel for positioning data displayed on the display screen; a touch pad configured to sense movement of an object along the touch pad, thereby enabling movement of a pointer on the display screen; and a joystick capable of being moved in a desired direction to move the pointer in the desired direction on the display screen.

In yet another aspect, the present invention provides a mobile tablet computer. The mobile tablet computer comprises: a central body housing a processing unit, the central body having a display screen; at least one handle coupled to the central body, the handle serving as a handgrip for holding the mobile tablet computer; a plurality of user interface features disposed on the handle; a keylock to prevent the user interface features from being depressed inadvertently; a power supply unit for powering the mobile tablet computer; a wireless network card for establishing a wireless communication link; a card slot capable of receiving external memory cards and functioning as external memory for the mobile tablet computer; an expansion slot for connecting the mobile tablet computer with external devices; an under carriage containment unit for storing unit for storing and accommodating at least one peripheral device; and an on/off power switch for powering on/off the mobile computer. The user interface features comprise: a plurality of control buttons for inputting data to the mobile tablet computer; a scroll wheel for positioning data displayed on the display screen; a touch pad configured to sense movement of an object along the touch pad, thereby enabling movement of a pointer on the display screen; and a joystick capable of being moved in a desired direction to move the pointer in the desired direction on the display screen.

These together with other aspects of the present invention, along with the various features of novelty that characterize the invention, are pointed out with particularity in the claims annexed hereto and forming a part of this invention. For a better understanding of the present invention, its operating advantages, and the specific objects attained by its uses, reference should be made to the accompanying drawings and descriptive matter in which, there are illustrated exemplary embodiments of the present invention.

### BRIEF DESCRIPTION OF THE DRAWINGS

The advantages and features of the present invention will become better understood with reference to the following more detailed description and claims taken in conjunction with the accompanying drawings, wherein:

FIG. 1 is a front view of a mobile tablet computer 100, according to an exemplary embodiment of the present invention;

FIG. 2 is a top view of the mobile tablet computer 100, according to an exemplary embodiment of the present invention; and

FIG. 3 is a back view of the mobile tablet computer 100, according to an exemplary embodiment of the present invention.

Like reference numerals refer to like parts throughout several views of the drawings of the present invention.

### DETAILED DESCRIPTION OF THE INVENTION

The exemplary embodiments described herein detail for illustrative purposes are subject to many variations in structure and design. It should be emphasized, however that the present invention is not limited to a particular mobile tablet computer as shown and described. It is understood that various omissions, substitutions of equivalents are contemplated as circumstances may suggest or render expedient, but is intended to cover the application or implementation without departing from the spirit or scope of the claims of the present invention. Also, it is to be understood that the phraseology and terminology used herein is for the purpose of description should not be regarded as limiting. The use of “including,” “comprising,” or “having” and variations thereof herein is meant to encompass the items listed thereafter and equivalents thereof as well as additional items. As used herein, the terms “a” and “an” do not denote a limitation of quantity, but rather denote the presence of at least one of the referenced item.

The present invention provides a mobile tablet computer, for use in rugged environments. The mobile tablet computer employs a plurality of user interface features for operating the mobile tablet computer. For example, the mobile tablet computer has control buttons for inputting data and scroll wheels for positioning the screen. Such user interface features are disposed on the mobile tablet computer at a position, such that, they may be easily operated using the user's thumb or rest of his fingers, thereby providing improved ergonomics during usage. Such easy operation of the mobile tablet computer is very useful for firefighters wearing big bulky gloves, military person, carpenters and other personnel working in rugged environments.

The present invention provides an improved, simplified, and efficient mobile tablet computer, for use in rugged environments. The mobile tablet computer of the present invention employs a plurality of user interface features enhancing the capabilities of the mobile tablet computer without imposing any limitation on location and orientation, in a fast, easy, consistent, reliable, inexpensive, and power efficient manner. The mobile tablet computer of the present invention has an attractive and aesthetically pleasing appearance and can be mass produced inexpensively.

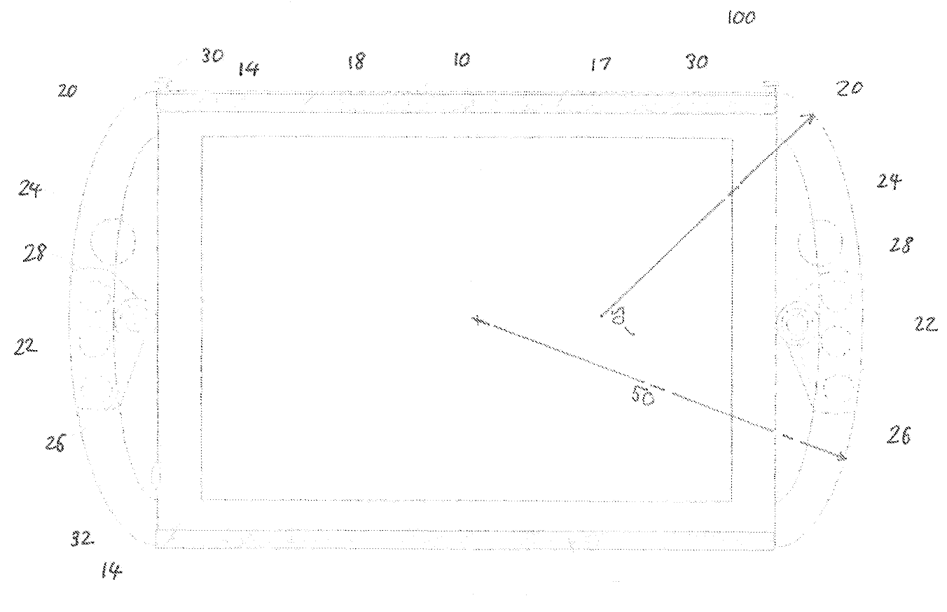

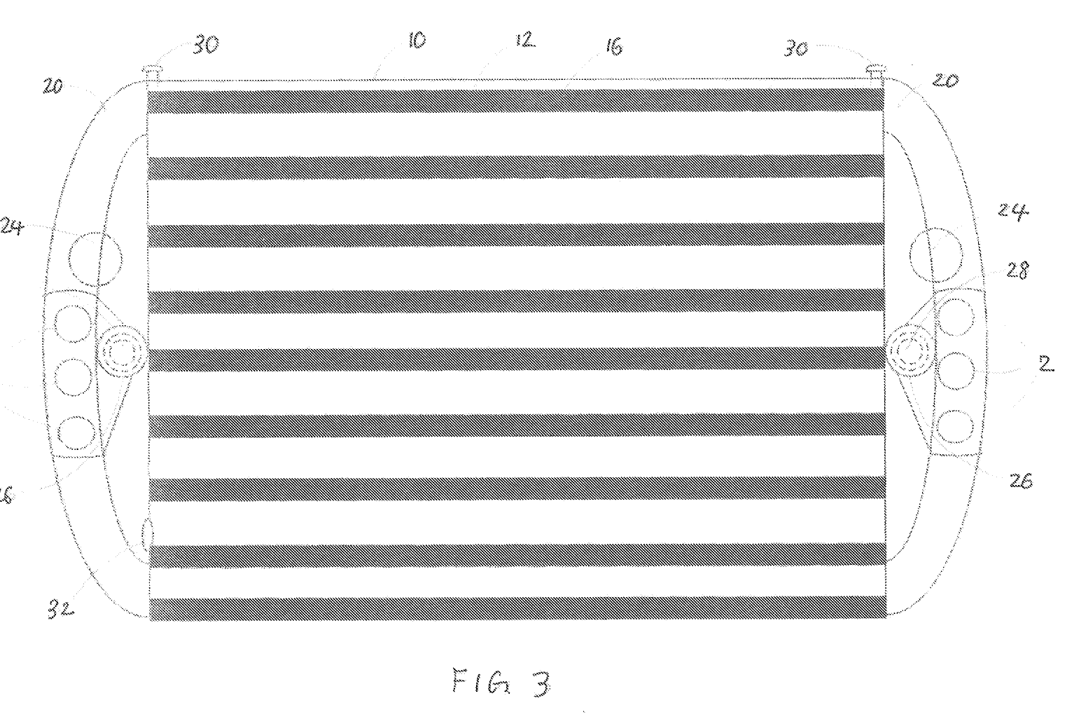

Referring to FIGS. 1-3, a mobile tablet computer 100, is shown. The mobile tablet computer 100 comprises a central body 10 capable of housing a processing unit (not shown), and handles 20 disposed on either side (i.e., a left side and a right side) of the central body 10 for holding the mobile tablet computer 100. The central body 10 may be made of any material providing sufficient structural integrity to the mobile tablet computer 100, such that, the mobile tablet computer 100 may be effectively used in rugged environments. In one embodiment, the central body 10 is made of a hard plastic material. Additionally, a plurality of strips 16 (See FIG. 3) made of a shock resistant material (rubber, and the like), may be disposed intermittently on a back surface 12 of the central body 10, to provide protection to the mobile tablet computer 100 from damages due to a fall and to provide surface friction to keep the unit in place if on an angled surface, for example. Although, the central body 10 has a rectangular shape, as shown in FIGS. 1-3, the central body 10 may take any other desired shape. Possible shapes for the central body 10 include, but are not limited to, square, circular, oval, elliptical, triangular, other rounded shapes, and irregular shapes.

The central body 10 may have a front surface 14 with a display screen 18. The display screen 18 can be embedded in the central body 10, as shown in FIG. 1. The display screen 18 may be a low power consumption display. Suitable displays include liquid crystal displays, organic light emitting displays, field emission displays, and the like. The front surface 14 of the central body 10 and the handles 20 can be covered with a protective shield. The protective shield may be made of any suitable material that provides protection to the mobile tablet computer 100 from unsuitable environmental conditions. Suitable materials include, but are not limited to, clear plastic, rubber, and mylar. This makes the mobile tablet computer 100 suitable for environmental conditions where water, soot, debris, sand, dust particles, heat, and other conditions or materials that may damage such units are present. Additionally, rubber guards 17 may be disposed on borders of the central body 10.

In one embodiment, the display screen 18 can be a touch screen to support an on screen keyboard to be operated by user's fingers or other devices capable of applying pressure points onto the display screen 18 using input means, such as, digital pens, stylus, and the like. The touch screen senses the touches applied on to it and communicate such touch events to the on screen keyboard or other input programs executing on the tablet computer 100. The display screen 18 is capable of receiving and interpreting handwritten data including signatures, through input means.

The handles 20 have a size, shape and configuration that provides for an easy and secure holding of the mobile table computer 100 during usage, and further providing sufficient space for disposal of various user interface features, and other regular features. In one embodiment, the handles 20 have a curved shape formed of an inwardly disposed radius 50, 50═, such that, the mobile tablet computer 100 may be easily and securely held in the user's hands.

The mobile tablet computer 100 further comprises a plurality of user interface features disposed on the handles 20 to provide improved ergonomics during usage of the mobile tablet computer 100 in rugged environments. In one embodiment the user interface features comprise control buttons 22, scroll wheel 24, touch pad 26, and joystick 28. Although, the user interface features are disposed on both the handles 20, as shown in FIG. 1, the user interface features may be disposed on only one of the handles 20.

The control buttons 22 of the tablet computer 100 may be embedded into a grip of the handle 20. The control buttons 22 are used to input data or to input a user's selection of an object on the touch screen such as icons, texts, menus or other input features, such as mouse clicks, and the like. The control buttons 22 may also include directional arrow buttons to enable a user to move a cursor on the display screen 18 or to scroll the display screen 18 (i.e., scroll the data displayed on the display screen 18). Optionally, the mobile tablet computer 100 can have keylocks 30 disposed on the top-left and top-right side of the mobile tablet computer 100 to prevent control buttons 22 from being depressed inadvertently.

The scroll wheel 24 may be positioned close to the control buttons 22, and can be disposed on a top side of the control buttons 22. The scroll wheel 24 may be used for positioning the display screen 18. More specifically, the scroll wheel 24 can enable the user to scroll the display screen 18 either vertically or horizontally, or both.

The touch pad 26 and joystick 28 can be positioned close to the control buttons 22 on a side of the control buttons 22 close to the display screen 18, thereby enabling the user to efficiently operate the mobile tablet computer 100 while wearing gloves. The touch pad 26 may be used as a pointing device for the mobile tablet computer 100. More specifically, the touch pad 26 is configured to sense the movement of user's finger, glove, or other object along the touch pad 26, enabling the movement of the pointer (cursor) on the display screen 18. The click function of the touch pad 26 may be enabled by tapping the touch pad 26. The joystick 28 may be configured to position the cursors on the display screen 18, by moving the joystick 28 in a desired direction. Also, the mobile tablet computer 100 has an on/off power switch 32 for powering on the mobile tablet computer 100 for use and powering off the mobile tablet computer 100, when not being used.

The mobile tablet computer 100 further can have a power supply unit for powering the display screen 18 and other components of the mobile tablet computer 100. The power supply unit may be a battery or fuel cell, a direct line from a wall outlet, current from a solar cell or any other power source sufficient to fulfill the power requirements for the mobile tablet computer 100. In one embodiment, the power supply unit may be a battery compartment 34 disposed on a top surface 15 of the central body 10. The battery compartment 34 may house a battery pack of rechargeable batteries, for providing mobile power to the mobile tablet computer 100. In another embodiment, the mobile tablet computer 100 may be connected to an external power source through a detachable power adapter.

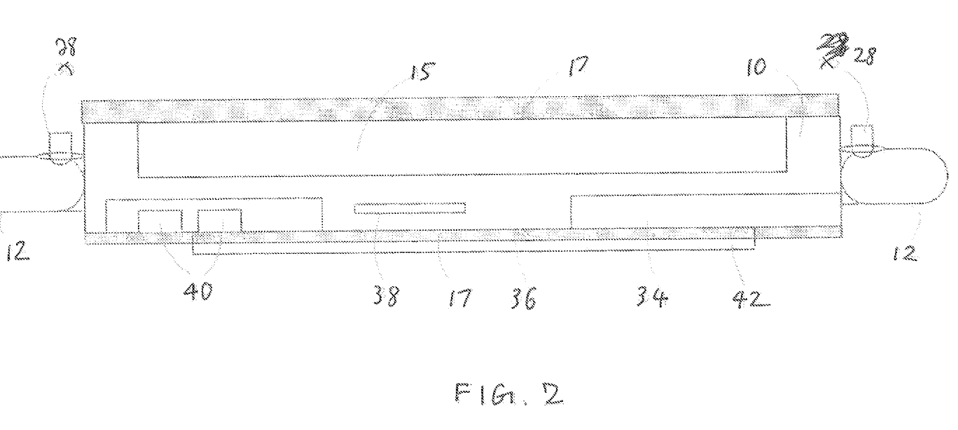

Referring to FIG. 2, a wireless network device or card 36 may electronically connect the mobile tablet computer 100 with a wireless communication network for establishing a wireless communication link. Such wireless communication link are advantageously used for communication between the mobile tablet computer 100 and other external devices such as portable computers, handheld units, workstations, main frame computers, other computer networks, and the like. The mobile tablet computer 100 further comprises card slots 38 on the top surface 15 of the central body 10 that can receive external memory cards (for example, Secure Data cards, Compact Flash cards, Smart Media cards, and the like) and function as external memory for the mobile tablet computer 100. Also, the mobile tablet computer 100 further can have an expansion slot(s) 40 (for example, PCI or PCMCIA slots), additional hardware interfaces, mouse, and keyboard ports (for example, serial, parallel, USB ports) for communication with other devices. When the expansion slots 40 are not in use, the expansion slots 40 may be plugged with rubber caps (not illustrated) for an airtight seal, thereby eliminating risk of unit contamination from water or dust. Optionally, the mobile tablet computer 100 can have an under carriage containment unit 42 for storing and accommodating peripheral devices such as stylus and other user interface detachable devices, when such devices are not in use.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

I claim:

1. A mobile tablet computer, comprising:
a central body capable of housing a processing unit, the central body having a display screen;
at least one handle coupled to the central body, the handle serving as a handgrip for holding the mobile tablet computer; and
a plurality of ergonomic user interface features disposed on the handle, the ergonomic user interface features comprising
a plurality of control buttons for inputting data to the mobile tablet computer, and
a scroll wheel for positioning at least one of a cursor or data displayed on the display screen.

2. The mobile tablet computer of claim 1, wherein the ergonomic user interface features further comprise a touch pad configured to sense movement of an object along the touch pad, thereby enabling movement of a pointer on the display screen.

3. The mobile tablet computer of claim 1, wherein the ergonomic user interface features further comprise a joystick capable of being moved in a desired direction to move a pointer in the desired direction on the display screen.

4. The mobile tablet computer of claim 1, further comprising at least one keylock to prevent the control buttons from being depressed inadvertently.

5. The mobile tablet computer of claim 1, further comprising a power supply unit for powering the mobile tablet computer.

6. The mobile tablet computer of claim 5, wherein the power supply unit is a battery compartment capable of housing a battery.

7. The mobile tablet computer of claim 1, further comprising a wireless compliant network card for establishing a wireless communication link.

8. The mobile tablet computer of claim 1, further comprising a card slot capable of receiving external memory cards and functioning as external memory for the mobile tablet computer.

9. The mobile tablet computer of claim 1, further comprising expansion slots for connecting the mobile tablet computer with external devices.

10. The mobile tablet computer of claim 1, further comprising an under carriage containment unit for storing and accommodating at least one peripheral device.

11. The mobile tablet computer of claim 1, further comprising an on/off power switch for powering on/off the mobile tablet computer.

12. The mobile tablet computer of claim 1, wherein the central body is made of a plastic material.

13. The mobile tablet computer of claim 1, wherein a plurality of strips made of a shock resistant material are disposed intermittently on a back surface of the central body.

14. The mobile tablet computer of claim 1, wherein the central body and the handles are covered with a protective shield.

15. The mobile tablet computer of claim 14, wherein the protective shield is made of a material selected from the group consisting of plastic, rubber, mylar, and combinations comprising at least one of the foregoing.

16. A mobile tablet computer, comprising:
a central body housing a processing unit, the central body having a front surface with a display screen;
a curved handle coupled to the central body, the handle serving as a handgrip for holding the mobile tablet computer; and
a plurality of ergonomic user interface features disposed on the handle, the ergonomic user interface features comprising
a plurality of control buttons for inputting data to the mobile tablet computer,
a scroll wheel for positioning data displayed on the display screen,
a touch pad configured to sense movement of an object along the touch pad, thereby enabling movement of a pointer on the display screen, and
a joystick capable of being moved in a desired direction to move the pointer in the desired direction on the display screen.

17. The mobile tablet computer of claim 16, wherein the central body is made of a plastic material.

18. The mobile tablet computer of claim 16, wherein a plurality of strips made of a shock resistant material are disposed intermittently on a back surface of the central body.

19. The mobile tablet computer of claim 16, wherein the central body and the handles are covered with a protective shield made of a material selected from the group consisting of plastic, rubber, mylar, and combinations comprising at least one of the foregoing.

20. A mobile tablet computer, comprising:
a central body housing a processing unit, the central body having a display screen;
at least one handle coupled to the central body, the handle serving as a handgrip for holding the mobile tablet computer;
a plurality of user interface features disposed on the handle, the user interface features comprising
a plurality of control buttons for inputting data to the mobile tablet computer,
a scroll wheel for positioning data displayed on the display screen,
a touch pad configured to sense movement of an object along the touch pad, thereby enabling movement of a pointer on the display screen, and
a joystick capable of being moved in a desired direction to move the pointer in the desired direction on the display screen;
a keylock to prevent the user interface features from being depressed inadvertently;
a power supply unit for powering the mobile tablet computer;
a wireless network card for establishing a wireless communication link;
a card slot capable of receiving external memory cards and capable of functioning as external memory for the mobile tablet computer;
an expansion slot for connecting the mobile tablet computer with external devices;
an under carriage containment unit for storing unit for storing and accommodating at least one peripheral device; and
an on/off power switch for powering on/off the mobile computer.
